(19) United States
(12) Patent Application Publication
(10) Pub. No.: US 2026/0186099 A1
(43) Pub. Date: Jul. 2, 2026

(54) RADAR APPARATUS, CLUTTER SUPPRESSION METHOD, AND CLUTTER SUPPRESSION PROGRAM

(71) Applicant: Furuno Electric Co., Ltd., Nishinomiya (JP)

(72) Inventor: Takuya FUJIMURA, Amagasaki (JP)

(21) Appl. No.: 19/546,772

(22) Filed: Feb. 23, 2026

Related U.S. Application Data
(63) Continuation of application No. PCT/JP2024/029271, filed on Aug. 19, 2024.

(30) Foreign Application Priority Data
Aug. 25, 2023 (JP) 2023-137421

(51) Int. Cl. G01S 7/35; G01S 13/58; G01S 13/89

(52) U.S. Cl. CPC G01S 7/354; G01S 13/581; G01S 13/89

(57) ABSTRACT

A radar device is provided with a transmitter configured to transmit electromagnetic waves, a vector similarity degree calculator configured to acquire amplitude information indicating an amplitude of a reflected signal reflected from a target by the electromagnetic waves and phase information indicating a phase of the reflected signal, a compatibility degree calculator configured to calculate the compatibility degree of clutter included in echo data based on the reflected signal using a membership function for each of the amplitude information and the phase information, the compatibility degree calculator configured to calculate a first compatibility degree corresponding to the amplitude information and a second compatibility degree corresponding to the phase information, and a clutter suppressor configured to suppress the clutter based on the first compatibility degree and the second compatibility degree.

### CROSS-REFERENCE TO RELATED APPLICATION(S)

This application is a bypass continuation of International Application No. PCT/JP2024/029271, filed on Aug. 19, 2024, which claims priority to Japanese Patent Application No. 2023-137421, filed on Aug. 25, 2023. The entire contents of the above applications are incorporated herein by reference.

### TECHNICAL FIELD

The present invention relates to a radar apparatus (device), clutter suppression method, and clutter suppression program.

### BACKGROUND

A technique for suppressing the influence of clutter in an echo image for detecting an object displayed by a radar apparatus (device) has been developed. For example, Japanese Unexamined Patent Application Publication No. 2012-108057 discloses the following target detection method. Specifically, the target detection method receives reflected echoes of detection signals transmitted successively from a rotating antenna and performs target detection from detection data obtained by sampling the received signals at predetermined timing intervals. The target detection method comprises a temporary storage step for temporarily storing detection data in a predetermined range and an echo identification step to identify a type of the reflected echoes based on variations in detection data values adjacent to each other within the predetermined range.

### SUMMARY

It is desirable to have a technology capable of suppressing clutter more reliably than the technology disclosed in conventional art document (JP2012-108057).

An object of the present invention is to provide a radar apparatus (device), a clutter suppression method, and a clutter suppression program capable of suppressing clutter more reliably.

(1) A radar, according to an aspect of the present invention, is provided with a transmitter configured to transmit electromagnetic waves; a vector similarity degree calculator configured to acquire amplitude information indicating an amplitude of a reflected signal reflected by a target and phase information indicating a phase of the reflected signal; a compatibility degree calculator configured to calculate a compatibility degree of clutter included in an echo data based on the reflected signal by using a membership function for each of the amplitude information and the phase information, and to calculate a first compatibility degree corresponding to the amplitude information and a second compatibility degree corresponding to the phase information; and a clutter suppressor configured to suppress the clutter based on the first compatibility degree and the second compatibility degree.

Thus, in estimating whether or not the echo data based on the reflected signal contains clutter, the estimation accuracy may be improved by using the phase of the reflected signal in addition to the amplitude of the reflected signal. Further, with the configuration in which the compatibility degree of the clutter is calculated for each of the amplitude and the phase of the reflected signal by using a membership function, it is possible to estimate whether or not the clutter is included in the echo data by fuzzy inference, so that the clutter to be suppressed may be accurately detected. Therefore, the clutter to be suppressed may be more reliably detected.

(2) In the above (1), the radar may further include a determiner configured to determine the clutter based on the first compatibility degree and second compatibility degree; and a display processor configured to display a determination result by the determiner.

With such configuration, it is possible to display the location where the clutter is occurring in the echo image indicating the presence or absence of a target in the detection target area. For example, the user may recognize the location as an area where rain or the like, which causes the clutter, is falling.

(3) In the above (1) or (2), the phase information may include a Doppler velocity width of the reflected signal.

For example, the Doppler velocity width of the clutter generated by the reflection of the electromagnetic wave transmitted from the radar on the rain is larger than the Doppler velocity width of the clutter generated by the reflection of the electromagnetic wave on the land. With the above configuration, it is possible to discriminate between the clutter generated by the reflection of the electromagnetic wave on the rain and the clutter generated by the reflection of the electromagnetic wave on the land.

(4) In any of the above (1) to (3), the phase information may include a vector similarity degree of the reflected signal, which is represented by the following equation (1):

$$CPA = \vert {\sum }_{i = 1}^{N} xi \vert / [ {\sum }_{i = 1}^{N} \vert xi \vert ] \qquad ( 1 )$$

where CPA is the vector similarity degree, N is the number of samples, and xi is a complex component of the reflected signal.

For example, the vector similarity degree of the clutter generated by the reflection of the electromagnetic wave transmitted from the radar on the land is greater than the vector similarity degree of the clutter generated by the reflection of the electromagnetic wave on the rain. With the above configuration, it is possible to discriminate between the clutter generated by the reflection of the electromagnetic wave on the rain and the clutter generated by the reflection of the electromagnetic wave on the land.

(5) In the above (3) or (4), the vector similarity degree calculator may perform a filtering procedure to smooth a waveform indicated by the reflected signal, and the amplitude information may include a correction value of the amplitude of the reflected signal after the filtering procedure.

In such a way, by using the correction value of the amplitude of the reflected signal after the filtering procedure to estimate whether or not the echo data based on the reflected signal contains clutter, it is possible to more accurately detect the clutter to be suppressed.

(6) In any of the above (1) to (5), the compatibility degree calculator may further perform a weighting procedure of the first compatibility degree and a weighting procedure of the second compatibility degree, and add the (weighted) first compatibility degree after the weighting procedure and the (weighted) second compatibility degree after the weighting procedure, and the clutter suppressor may perform the suppression procedure using normalized data obtained by normalizing the addition result by the compatibility degree calculator.

For example, the difference between the phase of the reflected signal from the target and the phase of the clutter is larger than the difference between the amplitude of the reflected signal from the target and the amplitude of the clutter. With the above configuration, for example, by making the weighting of the second compatibility degree corresponding to the phase larger than the weighting of the first compatibility degree corresponding to the amplitude, it is possible to more accurately estimate whether or not the echo data based on the received reflected signal contains clutter, so that the clutter may be more reliably suppressed.

(7) In the above (6), the clutter suppressor may perform a threshold calculation procedure to calculate a threshold for suppressing the clutter based on the normalized data, and to subtract the threshold from the echo data in the suppression procedure.

With the above configuration, the clutter included in the echo data may be easily suppressed using the threshold based on the compatibility degree of the clutter calculated by fuzzy inference.

(8) In the above (7), the transmitter may transmit the electromagnetic wave via a transmission antenna (i.e., rotating transmission antenna), the clutter suppressor may calculate a first threshold, which is the threshold in the rotating direction of the transmission antenna, in the threshold calculation procedure using the following equation (2), and may calculate a second threshold, which is the threshold in the direction from the radar towards the target, using the following equation (3), and the clutter suppressor may subtract the second threshold from the echo data in the suppression procedure.

$$Tha [ i ] = Tha [ i ] \times W 1 \times ( 1 - Q ) + ( S [ i ] \times ( 1 - W 1 \times ( 1 - Q ) ) ) \qquad ( 2 )$$

$$Thb [ i ] = Thb [ i - 1 ] \times W 2 \times ( 1 - Q ) + ( T ha [ i ] \times ( 1 - W 2 \times ( 1 - Q ) ) ) \qquad ( 3 )$$

where, Tha[i] is the first threshold, Thb[i] is the second threshold, S[i] is the echo data, W1 and W2 are predetermined coefficients, Q is the normalized data, and i is an integer equal to or greater than 0 and equal to or less than the number of samples.

With such configuration, the threshold used for suppressing clutter may be easily calculated by substituting the normalized data based on the compatibility degree of the clutter corresponding to the amplitude of the reflected signal and the compatibility degree of the clutter corresponding to the phase of the reflected signal into a predetermined calculation equation.

(9) In any of (1) to (6) above, the clutter suppressor may substitute the echo data with zero (0) when the first compatibility degree is equal to or greater than a predetermined first threshold value or the second compatibility degree is equal to or greater than a predetermined second threshold value with 0 in the suppression procedure.

With such configuration, it is possible to estimate whether or not clutter is included in the echo data according to the compatibility degree value calculated by fuzzy inference, and when clutter is included in the echo data, it is possible to more reliably suppress clutter by replacing the echo data with 0.

(10) In order to solve the above-mentioned problems, a clutter suppression method, according to an aspect of the present invention is provided with transmitting an electromagnetic wave, acquiring amplitude information indicating an amplitude of a reflected signal reflected by a target and phase information indicating a phase of the reflected signal, calculating a compatibility degree of clutter included in echo data based on the reflected signal by using a membership function for each of the amplitude information and the phase information, and calculating a first compatibility degree corresponding to the amplitude information and a second compatibility degree corresponding to the phase information; and suppressing the clutter based on the first compatibility degree and the second compatibility degree.

As described above, when estimating whether or not clutter is included in the echo data based on the reflected signal, estimation accuracy may be improved by the configuration using the phase of the reflected signal in addition to the amplitude of the reflected signal. In addition, by the configuration using the membership function to calculate the compatibility degree of clutter for each of the amplitude and the phase of the reflected signal, it is possible to estimate whether or not clutter is included in the echo data by fuzzy inference, and therefore the clutter to be suppressed may be accurately detected. Therefore, clutter may be suppressed more reliably.

(11) A clutter suppression program, according to an aspect of the present invention, is a clutter suppression program for a radar, and is a program for causing a computer to execute a process of: transmitting an electromagnetic wave, acquiring amplitude information indicating an amplitude of a reflected signal reflected by a target and phase information indicating a phase of the reflected signal, calculating a compatibility degree of clutter included in echo data based on the reflected signal by using a membership function for each of the amplitude information and the phase information, and calculating a first compatibility degree corresponding to the amplitude information and a second compatibility degree corresponding to the phase information; and suppressing the clutter based on the first compatibility degree and the second compatibility degree.

Thus, in estimating whether or not clutter is included in the echo data based on the reflected signal, the estimation accuracy may be improved by the configuration using the phase of the reflected signal in addition to the amplitude of the reflected signal. In addition, by the configuration in which the compatibility degree of the clutter is calculated using the membership function for each of the amplitude and phase of the reflected signal, whether or not clutter is included in the echo data may be estimated by fuzzy inference, so that the clutter to be suppressed may be accurately detected. Therefore, clutter may be suppressed more reliably. According to the present invention, the clutter may be suppressed more reliably.

### BRIEF DESCRIPTION OF DRAWINGS

FIG. 1 is a diagram showing a configuration of a radar apparatus according to an embodiment of the present invention.

FIG. 2 is a diagram showing an example of an echo image displayed by the radar apparatus according to an embodiment of the present invention.

FIG. 3 is a diagram showing an example of a configuration of a vector similarity degree calculator in the radar apparatus according to an embodiment of the present invention.

FIG. 4 is a diagram showing an example of the echo image displayed by the radar apparatus using a calculation result of a Doppler velocity width of a reflected signal according to an embodiment of the present invention.

FIG. 5 is a diagram showing an example of the echo image displayed by the radar apparatus using the calculation result of a vector similarity degree of a reflected signal according to an embodiment of the present invention.

FIG. 6 shows an example of the reflected signal smoothed by the radar apparatus according to the embodiment of the present invention.

FIG. 7 shows a correction process by the radar apparatus according to the embodiment of the present invention.

FIG. 8 shows an example of the echo image displayed by the radar apparatus using the calculation result of the correction value of the amplitude of the reflected signal according to the embodiment of the present invention.

FIG. 9 shows an example of a membership function used in the compatibility degree calculation process by the radar apparatus according to the embodiment of the present invention.

FIG. 10 is a diagram showing another example of the membership function used in the compatibility degree calculation procedure by the radar apparatus according to the embodiment of the present invention.

FIG. 11 is a diagram showing another example of the membership function used in the compatibility degree calculation procedure by the radar apparatus according to the embodiment of the present invention.

FIG. 12 is a diagram showing another example of the echo image displayed by the radar apparatus according to the embodiment of the present invention.

FIG. 13 is a diagram showing another example of the echo image displayed by the radar apparatus according to the embodiment of the present invention.

FIG. 14 is a flowchart showing an operation procedure when the radar apparatus performs suppression procedure according to the embodiment of the present invention.

### DESCRIPTION OF EMBODIMENTS

Embodiments of the present invention is described below with reference to the drawings. It should be noted that the same or corresponding portions in the figures are denoted by the same reference numerals, and the description thereof is not repeated. At least some of the embodiments described below may be arbitrarily combined.

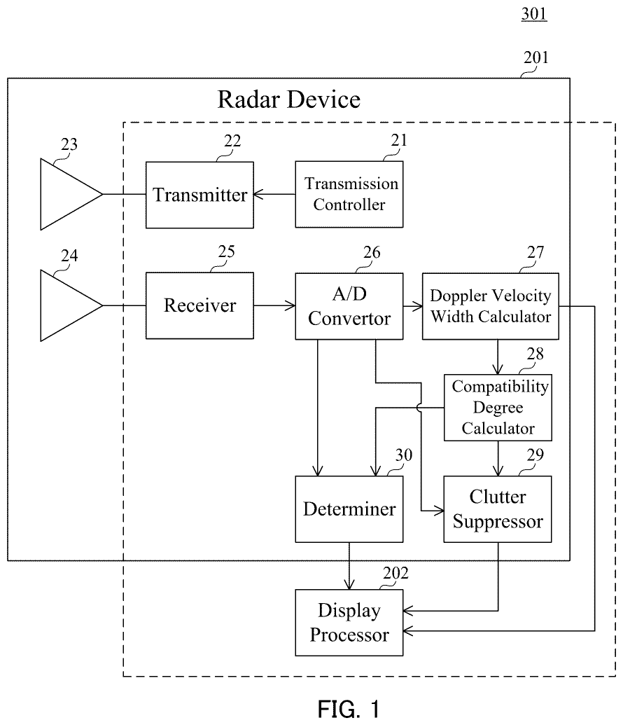

FIG. 1 is a diagram showing a configuration of a radar apparatus (301), according to an embodiment of the present invention. Referring to FIG. 1, the radar apparatus (301) includes a radar device (201) and a display processor (202). The radar device (201) includes a transmission controller (21), a transmitter (22), a transmission antenna (23), a reception antenna (24), a receiver (25), an A/D converter (26), a Doppler velocity width calculator (27), a compatibility degree calculator (28), a clutter suppressor (29), and a determiner (30). Some or all of the transmission controller (21), the transmitter (22), the receiver (25), the A/D converter (26), the Doppler velocity width calculator (27), the compatibility degree calculator (28), the clutter suppressor (29), the determiner (30), and the display processor (202) are realized, for example, by processing circuitry including one or more processors as illustrated within the dotted line in FIG. 1.

The radar apparatus (301) is, for example, a pulse-type radar apparatus. The radar apparatus (301) is, for example, mounted on a ship. The radar apparatus (301) displays, on a display device (not shown), an echo image indicating a presence or absence of a target in a detection target area, which is a region monitored by the ship, and a distance between the radar apparatus (301) and the target. A ship is an example of a water moving body.

It is to be noted that that the radar apparatus (301) is not limited to a pulse type radar apparatus, but may be another type of radar apparatus (301) different from the pulse type, for example, a Frequency Modulated Continuous Wave (FM-CW) type radar apparatus.

The radar device (201) outputs echo data indicating a detection result of the target in the detection target area to the display processor (202). The transmission antenna (23) and the reception antenna (24) rotate so that an azimuth angle in a radiation direction of the electromagnetic waves by the transmission antenna (23) changes by a predetermined angle every predetermined sweep period (St). Thus, the radar device (201) may detect the target existing in all directions around a vessel on which the radar apparatus (301) is mounted. Hereinafter, the rotational direction of the transmission antenna (23) and the reception antenna (24) may also be referred to as “azimuth direction”. The operation of receiving the reflected signal by rotating the reception antenna (24) by 360 degrees may be referred to as “scanning”.

The radar device (201) outputs echo data indicating the detection result of the target in the detection target area for each sweep period (St) to the display processor (202).

The display processor (202) displays the echo image in the detection target area on the display device based on a plurality of echo data received from the radar device (201).

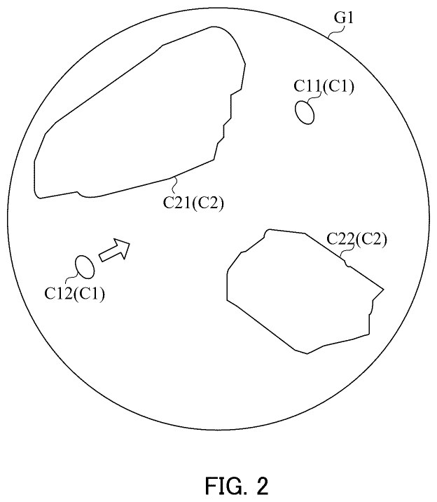

FIG. 2 is a diagram showing an example of the echo image displayed by the radar device (201), according to the embodiment of the present invention.

Referring to FIG. 2, an echo image (G1) includes a reflected signal (hereinafter, it is also referred to as “target echo (C1)”) from the target. A clutter (C2) is a reflected signal in which electromagnetic waves transmitted from the radar apparatus (301) are reflected by rain, snow, land, sea surface, or the like.

In the example, shown in FIG. 2, the echo image (G1) shows an intensity of rain clutter (C21) as clutter (C2) and an intensity of land clutter (C22) as clutter (C2). A rain clutter (C21) is a clutter (C2) generated when electromagnetic waves transmitted from the radar apparatus (301) are reflected by rain. A land clutter (C22) is a clutter (C2) generated when electromagnetic waves are reflected by land.

The echo image (G1) includes the reflected signal (hereinafter, it is also referred to as “stationary object target echo (C11)”) from a stationary target. The intensity of the reflected signal (hereinafter, it is also referred to as “moving object target echo (C12)”) from a moving target is shown.

Radar Apparatus/Device—The transmitter (22) transmits electromagnetic waves via the transmission antenna (23) i.e., rotating transmission antenna. More specifically, for example, the transmitter (22) transmits a pulsed electromagnetic wave (hereinafter, it is also referred to as “transmission wave”) during the sweep period (St).

Specifically, for example, the transmission controller (21) outputs a pulse-like transmission trigger to the transmitter (22).

The transmitter (22) generates a transmission wave according to the transmission trigger received from the transmission controller (21). Then, the transmission controller (21) transmits the generated transmission wave to the detection target area via the transmission antenna (23). The transmitter (22) includes, for example, a magnetron used for generating the transmission wave. The transmitter (22) generates the transmission wave having a frequency unique to the magnetron.

The receiver (25) receives the reflected signal in which the transmission wave is reflected by the target or the like. More specifically, the receiver (25) receives a radio frequency (RF) band reflected signal in which the transmission wave is reflected by the target or the like in the detection target area through the rotating reception antenna (24). The receiver (25) outputs the received reflected signal to the A/D converter (26).

Specifically, for example, the receiver (25) includes a low noise amplifier. The low noise amplifier amplifies the reflected signal of the RF band received via the reception antenna (24) and outputs the amplified signal to the A/D converter (26).

The A/D converter (26) converts a reflected signal (SA), which is an analog signal received from the receiver (25), into a reflected signal (SD), which is a digital signal, by sampling at a predetermined sampling frequency (fs), and outputs the signal to the Doppler velocity width calculator (27), the clutter suppressor (29), and the determiner (30).

More specifically, for example, the A/D converter (26) generates N reflected signals (SD) by sampling at the predetermined sampling frequency (fs) every sweep period (St), and outputs the signal to the Doppler velocity width calculator (27). N is an integer of 1 or more.

The Doppler velocity width calculator (27) acquires phase information indicating the phase of the reflected signal (SD) and amplitude information indicating the amplitude of the reflected signal (SD).

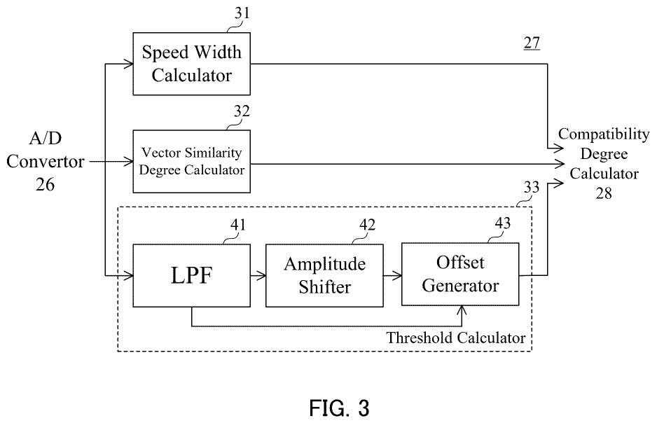

FIG. 3 is a diagram showing an example of the configuration of the vector similarity degree calculator in the radar apparatus (301), according to the embodiment of the present invention. Referring to FIG. 3, the Doppler velocity width calculator (27) includes a speed width calculator (31), a vector similarity degree calculator (32), and a threshold calculator (33). The threshold calculator (33) includes a Low Pass Filter (LPF) (41), an amplitude shifter (42), and an offset generator (43).

More specifically, for example, the phase information includes the Doppler velocity width (σ) of the reflected signal (SD). Specifically, for example, the speed width calculator (31) calculates the Doppler velocity width (σ) using an autocorrelation function R(j) of the reflected signal (SD) received from the A/D converter (26). The autocorrelation function R(j) is expressed, for example, by the following equation (4). In the equation (4), S(i) is the ith reflected signal (SD) of the N reflected signals (SD), and S(i+j) is the {i+j}th reflected signal (SD) of the N reflected signals (SD). j is a value in the range from 0 to N.

$$R ( j ) = \frac{1}{N} {\sum }_{i = 1}^{N} S ( i ) \times S ( i + j ) \qquad ( 4 )$$

The Doppler velocity width calculator (27) calculates the autocorrelation function R(T) when j is a number corresponding to a pulse repetition period (T) of the transmitted wave in the equation (4). The Doppler velocity width calculator (27) calculates the autocorrelation function R(0) when j is 0 in the equation (4).

Then, the Doppler velocity width calculator (27) calculates the Doppler velocity width (σ) of the reflected signal (SD) by substituting the autocorrelation functions R(T) and R(0) into the following equation (5). In the equation (5), σ is the Doppler velocity width and λ is a wavelength of the transmitted wave.

$$σ = \frac{λ}{2 \sqrt{2}} \times \sqrt{1 - \frac{\vert R ( T ) \vert}{R ( 0 )}} \qquad ( 5 )$$

The Doppler velocity width (σ) of the rain clutter (C21) is different from the Doppler velocity width (σ) of the land clutter (C22). For example, the Doppler velocity width (σ) of the rain clutter (C21) is larger than the Doppler velocity width (σ) of the land clutter (C22). When the Doppler velocity width calculator (27) calculates the Doppler velocity width (σ) of the reflected signal (SD), it outputs the calculated Doppler velocity width (σ) to the compatibility degree calculator (28).

The radar apparatus (301) may be configured to use the calculated Doppler velocity width (σ) to determine the type of the received reflected signal and display the determination result on the display device. In case, for example, when the calculated Doppler velocity width (σ) is equal to or greater than a predetermined threshold (Th1), the Doppler velocity width calculator (27) determines that the reflected signal corresponding to the calculated Doppler velocity width (σ) is rain clutter (C21). On the other hand, when the calculated Doppler velocity width (σ) is less than the predetermined threshold (Th1), the Doppler velocity width calculator (27) determines that the reflected signal corresponding to the Doppler velocity width (σ) is not rain clutter (C21). Then, the Doppler velocity width calculator (27) outputs a determination result information (P1) indicating the determination result of the reflected signal using the Doppler velocity width (σ) to the display processor (202).

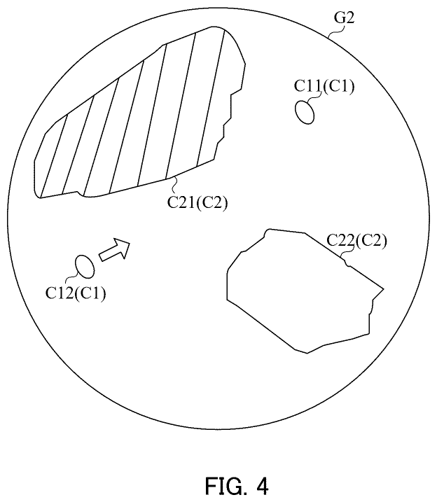

FIG. 4 is a diagram showing an example of the echo image displayed by the radar apparatus (301) using the calculation result of the Doppler velocity width (σ) of the reflected signal (SD), according to the embodiment of the present invention.

Referring to FIG. 4, for example, the display processor (202) displays an echo image (G2) indicating the determination result of the reflected signal using the Doppler velocity width (σ) on the display device based on the determination result information (P1) received from the Doppler velocity width calculator (27). In the echo image (G2), the rain clutter (C21) having the Doppler velocity width (σ) equal to or greater than the predetermined threshold (Th1) is hatched, and the land clutter (C22) and the target echo (C1) having the Doppler velocity width (σ) less than the predetermined threshold (Th1) are not hatched.

For example, the phase information includes, in addition to the Doppler velocity width (σ), the vector similarity degree of the reflected signal (SD) represented by the following equation (6). In the equation (6), CPA is the vector similarity degree, N is the number of samples, and xi is a complex component of the reflected signal.

Referring again to FIG. 3, specifically, for example, the Doppler velocity width calculator (27) calculates the clutter phase alignment (CPA), also referred to herein as a vector similarity degree, by substituting N reflected signals (SD) received from the A/D converter (26) into the following equation (6). The vector similarity degree (CPA) is, for example, a value in a range from 0 to 1.

$$CPA = \vert {\sum }_{i = 1}^{N} xi \vert / [ {\sum }_{i = 1}^{N} \vert xi \vert ] \qquad ( 6 )$$

The vector similarity degree (CPA) of rain clutter (C21) is a value different from the vector similarity degree (CPA) of land clutter (C22). For example, the vector similarity degree (CPA) of rain clutter (C21) is a value smaller than the vector similarity degree (CPA) of land clutter (C22). When the Doppler velocity width calculator (27) calculates the vector similarity degree (CPA) of the reflected signal (SD), it outputs the calculated vector similarity degree (CPA) to the compatibility degree calculator (28).

The radar apparatus (301) may use the calculated vector similarity degree (CPA) to determine the type of the received reflected signal and display the determination result on the display device. In this case, for example, when the calculated vector similarity degree (CPA) is equal to or greater than a predetermined threshold (Th2), the Doppler velocity width calculator (27) determines that the reflected signal corresponding to the calculated vector similarity degree (CPA) is land clutter (C22) or the stationary object target echo (C11). On the other hand, when the calculated vector similarity degree (CPA) is less than the predetermined threshold (Th2), then the Doppler velocity width calculator (27) determines that the reflected signal corresponding to the calculated vector similarity degree (CPA) is neither land clutter (C22) nor a stationary object target echo (C11). Then, the Doppler velocity width calculator (27) outputs a determination result information (P2) indicating the determination result of the reflected signal using the vector similarity degree (CPA) to the display processor (202).

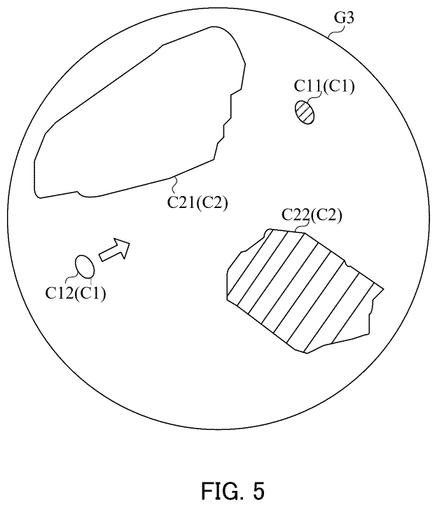

FIG. 5 is a diagram showing an example of the echo image displayed by the radar apparatus (301) using the calculation result of the vector similarity degree (CPA) of the reflected signal, according to the embodiment of the present invention.

Referring to FIG. 5, for example, the display processor (202) displays an echo image (G3) indicating the determination result of the reflected signal using the vector similarity degree (CPA) on a display device based on the determination result information (P2) received from the Doppler velocity width calculator (27). In the echo image (G3), the land clutter (C22) and the stationary object target echo (C11) whose vector similarity degree is equal to or greater than the threshold (Th2) are hatched, and the rain clutter (C21) and the moving object target echo (C12) whose vector similarity degree is less than the threshold (Th2) are not hatched.

Further, the Doppler velocity width calculator (27) may acquire either the Doppler velocity width (σ) or the vector similarity degree as phase information. The radar apparatus (301) may also acquire other index values indicating the phase of the reflected signal as phase information, other than the Doppler velocity width (σ) and the vector similarity degree.

For example, in the threshold calculator (33), the LPF (41) performs filtering procedure for smoothing the waveform indicated by the reflected signal (SD) received from the A/D converter (26). The LPF (41) is, for example, an Infinite Impulse Response (IIR) filter.

In the present embodiment, for example, the threshold calculator (33) acquires, as amplitude information, a correction value (M) of the amplitude of the waveform indicated by the filtered reflected signal (SD). In the following description, for simplicity, the amplitude of the waveform indicated by the reflected signal (SD), which is a digital signal, is simply referred to as “the amplitude of the reflected signal (SD)”.

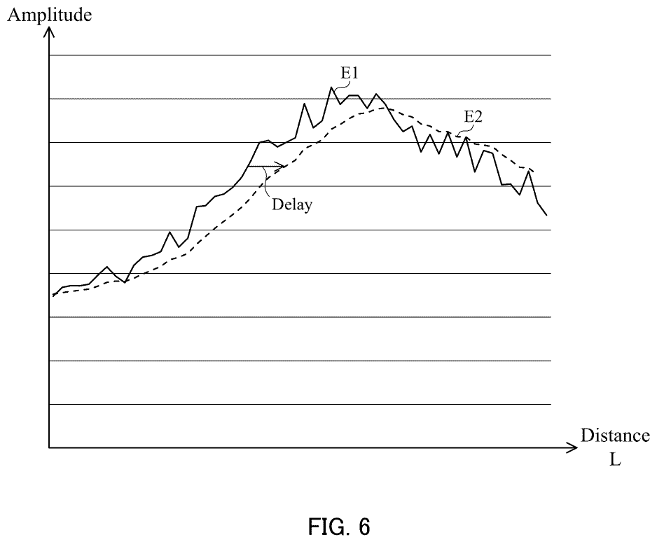

FIG. 6 is a diagram showing an example of the reflected signal smoothed by the radar apparatus (301), according to the embodiment of the present invention. In FIG. 6, a horizontal axis indicates the distance (L) from the radar apparatus (301), and a vertical axis indicates the amplitude.

Referring to FIG. 6, a graph (E1) shown by a solid line indicates the relationship between the amplitude of the reflected signal (SD) before filtering and the distance. A graph (E2) shown by a broken line indicates the relationship between the amplitude of the reflected signal (SD) after filtering and the distance. As shown in graphs (E1) and (E2), the amplitude of the reflected signal (SD) after filtering is shifted in the direction (Hereinafter, it is also referred to as “distance direction”) from the radar apparatus (301) towards the target relative to the amplitude of the reflected signal (SD) before filtering. That is, the reflected signal (SD) after filtering may be delayed in the distance direction relative to the reflected signal (SD) before filtering.

Referring again to FIG. 3, the LPF (41) outputs the reflected signal (SD) after filtering to the amplitude shifter (42) and the offset generator (43).

The amplitude shifter (42) performs correction procedure to correct the reflected signal (SD) that may be passed the LPF (41). Specifically, for example, the amplitude shifter (42) calculates a difference value (B1) between the amplitude of the reflected signal (SD) after filtering indicated by the graph (E2) and the amplitude of the reflected signal (SD) before filtering indicated by the graph (E1) for each distance (L) from the radar device (201). Then, the amplitude shifter (42) checks whether or not the calculated difference value (B1) is equal to or greater than a predetermined threshold value (Tb) for each distance (L).

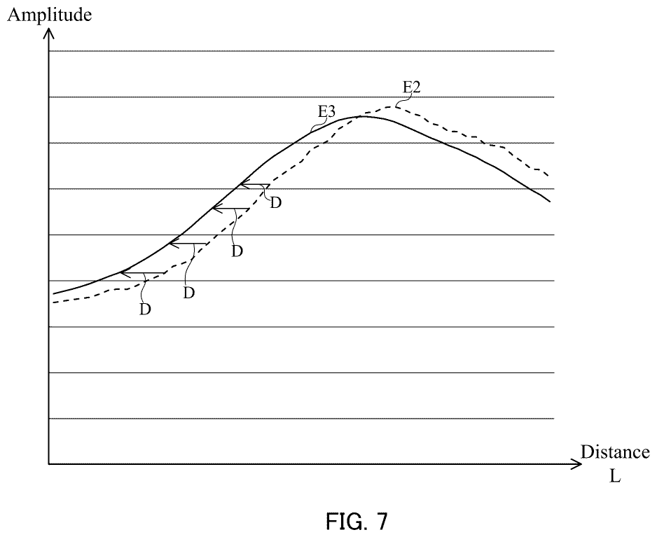

FIG. 7 is a diagram for explaining the correction procedure by the radar apparatus (301), according to the embodiment of the present invention. In FIG. 7, a graph (E3) shown by a solid line shows the relationship between the amplitude of the reflected signal (SD) after the correction procedure and the distance. A graph (E2) shown by a broken line shows the relationship between the amplitude of the reflected signal (SD) before the correction procedure and the distance, that is, the relationship between the amplitude of the reflected signal (SD) after the filtering procedure shown in FIG. 6 and the distance.

Referring to FIGS. 3 and 7, the amplitude shifter (42) estimates a delay amount (D) of the amplitude of the reflected signal (SD) after the filtering procedure shown in the graph (E2) for each distance (L) based on the filter coefficient used in the filtering procedure by the LPF (41). Then, the amplitude shifter (42) shifts the amplitude of the reflected signal (SD) after the filtering procedure at a distance where the difference value (B1) is less than the predetermined threshold value (Tb) in a direction approaching the radar apparatus (301) by the estimated delay amount (D). The amplitude shifter (42) outputs the reflected signal (SD) after the correction procedure to the offset generator (43).

Referring to FIGS. 6 and 7, the offset generator (43) calculates a difference value (B2) between the amplitude of the reflected signal (SD) before the filtering procedure shown in the graph (E1) and the amplitude of the reflected signal (SD) after the correction procedure shown in the graph (E3) for each distance (L). The offset generator (43) repeats the procedures of calculating the difference value (B2) for each distance (L) for a predetermined number of scans.

Then, the offset generator (43) calculates a statistical value of the difference value (B2) for each distance (L). For example, the offset generator (43) calculates a standard deviation (H) of the difference value (B2) as the statistical value for each distance (L).

When the offset generator (43) calculates the standard deviation (H) at each distance (L), it calculates a value obtained by multiplying the standard deviation (H) by a predetermined coefficient α as the offset value.

Then, for each distance (L), the offset generator (43) calculates a value obtained by adding the amplitude of the reflected signal (SD) after correction procedure indicated by the graph (E3) and the calculated offset value as the correction value (M). The Doppler velocity width calculator (27) outputs the calculated correction value (M) to the compatibility degree calculator (28).

The radar apparatus (301) may use the calculated correction value (M) to determine the type of the received reflected signal and display the determination result on the display device. In the case, for example, when the calculated correction value (M) is equal to or greater than a predetermined threshold value (Th3), then the Doppler velocity width calculator (27) determines that the reflected signal corresponding to the correction value (M) is clutter (C2). On the other hand, when the calculated correction value (M) is less than the predetermined threshold value (Th3), then the Doppler velocity width calculator (27) determines that the reflected signal corresponding to the correction value (M) is not clutter (C2). Thereafter, the Doppler velocity width calculator (27) outputs the determination result information (P3) indicating the determination result of the reflected signal using the correction value (M) to the display processor (202).

The Doppler velocity width calculator (27) may also acquire other index values indicating the amplitude of the reflected signal as amplitude information, not limited to the correction value (M).

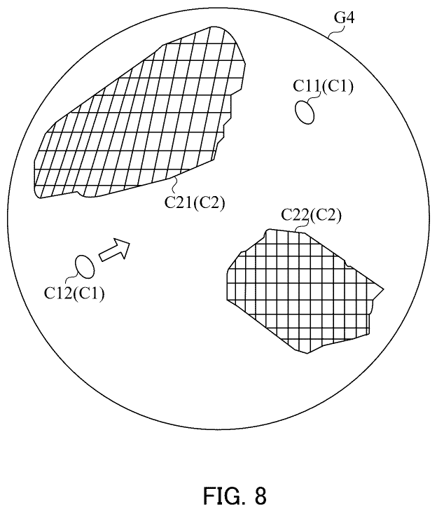

FIG. 8 is a diagram showing an example of the echo image displayed by the radar apparatus (301) using the calculation result of the correction value (M) of the amplitude of the reflected signal, according to the embodiment of the present invention.

Referring to FIG. 8, the display processor (202) displays on the display device an echo image (G4) indicating the result of the determination of the reflected signal using the correction value (M) based on the determination result information (P3) received from the Doppler velocity width calculator (27). In the echo image (G4), the clutter (C2) having the correction value (M) equal to or greater than the predetermined threshold (Th3), that is, the rain clutter (C21) and the land clutter (C22) are hatched, and the target echo (C1) having the correction value (M) less than the predetermined threshold (Th3), that is, the stationary object target echo (C11) and the moving object target echo (C12) are not hatched.

The compatibility degree calculator (28) performs compatibility degree calculation procedure configured to calculate the compatibility degree of the clutter (C2) included in the echo data based on the reflected signal for each distance (L) by using a membership function (F) for each of the amplitude information and the phase information. The compatibility degree is an index value indicating the possibility that the echo data includes clutter (C2).

More specifically, the compatibility degree calculator (28) calculates a compatibility degree (A2) corresponding to the amplitude information and the compatibility degrees (A11) and (A12) corresponding to the phase information. The compatibility degree (A2) is an example of the first compatibility degree, and the compatibility degrees (A11) and (A12) are examples of the second compatibility degree.

More specifically, for example, in the compatibility degree calculation procedure, the compatibility degree calculator (28) calculates the compatibility degree (A11) corresponding to the Doppler velocity width (σ) which is an example of the amplitude information, the compatibility degree (A12) corresponding to the vector similarity degree (CPA) which is an example of the amplitude information, and the compatibility degree (A2) corresponding to the correction value (M) which is an example of the amplitude information.

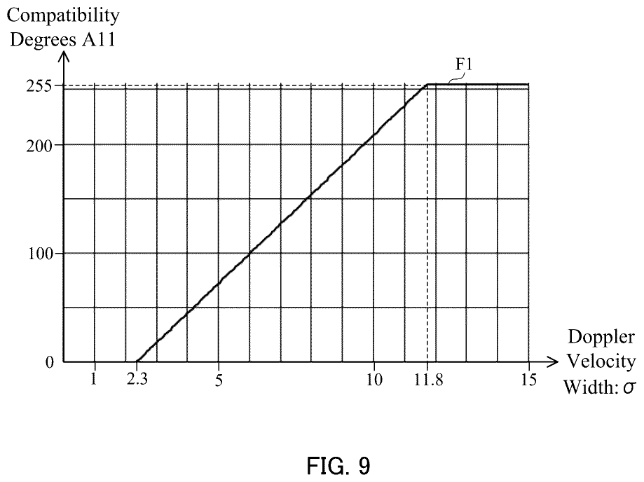

FIG. 9 is a diagram showing an example of the membership function used in the compatibility degree calculation procedure by the radar apparatus (301), according to the embodiment of the present invention. FIG. 9 is a diagram showing a membership function (F1) which is a membership function (F) used configured to calculate the compatibility degree (A11). In FIG. 9, the horizontal axis indicates the Doppler velocity width (σ) and the vertical axis indicates the compatibility degree (A11).

Referring to FIG. 9, in the membership function (F1), the compatibility degree (A11) increases in proportion to the Doppler velocity width (σ) in the range of the Doppler velocity width (σ) from 2.3 to 11.8. The compatibility degree (A11) is a constant value in the range of the Doppler velocity width (σ) from 11.8 to 15. In the example. shown in FIG. 9, the value of the compatibility degree (A11) increases from 0 to 255 in the range of the Doppler velocity width (σ) from 2.3 to 11.8. The value of the compatibility degree (A11) is 255 in the range of the Doppler velocity width (σ) from 11.8 to 15. That is, for example, the compatibility degree (A11) is a value in the range of 0 to 255.

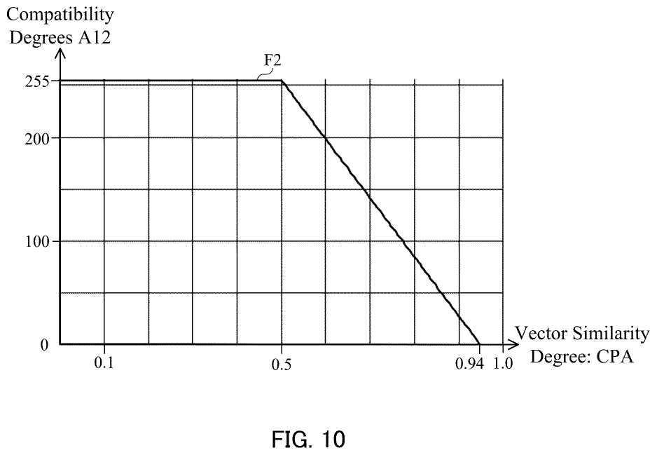

FIG. 10 is a diagram showing another example of the membership function used in the compatibility degree calculation procedure by the radar apparatus (301), according to the embodiment of the present invention. FIG. 10 is a diagram showing a membership function (F2) used to calculate the compatibility degree (A12). In FIG. 10, the horizontal axis indicates the vector similarity degree (CPA) and the vertical axis indicates the compatibility degree (A12).

Referring to FIG. 10, in the membership function (F2), the compatibility degree (A12) is a constant value in the range of the vector similarity degree (CPA) from 0 to 0.5. The compatibility degree (A12) decreases in the range of the vector similarity degree (CPA) from 0.5 to 0.94. In the example, shown in FIG. 10, the value of the compatibility degree (A12) is 255 in the range of the vector similarity degree (CPA) from 0 to 0.5. The value of the compatibility degree (A12) decreases from 255 to 0 in the range of the vector similarity degree (CPA) from 0.5 to 0.94. That is, for example, the compatibility degree (A12) is a value in the range of 0 to 255.

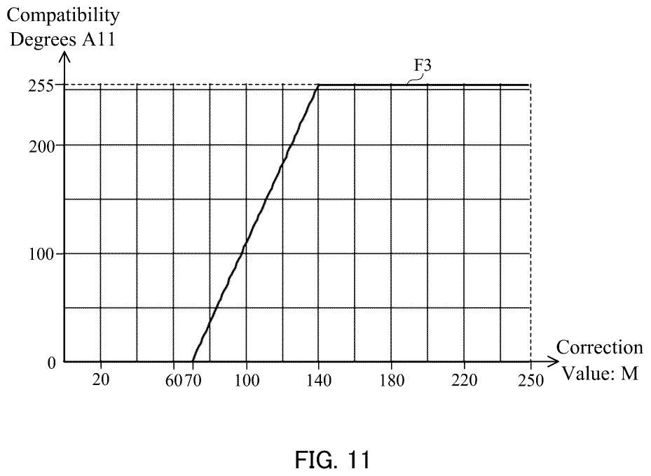

FIG. 11 is a diagram showing another example of the membership function used in the compatibility degree calculation procedure by the radar apparatus (301), according to the embodiment of the present invention. FIG. 11 is a diagram showing a membership function (F3) that is a membership function (F) used to calculate the compatibility degree (A2). In FIG. 11, the horizontal axis indicates the correction value (M) and the vertical axis indicates the compatibility degree (A2).

Referring to FIG. 11, in the membership function (F3), the compatibility degree (A2) increases in proportion to the correction value (M) in the range of the correction value (M) from 63 to 140. The compatibility degree (A2) is a constant value in the range of the correction value (M) from 140 to 250. In the example, shown in FIG. 11, the value of the compatibility degree (A2) increases from 0 to 255 in the range of the correction value (M) from 63 to 140. The value of the compatibility degree (A2) is 255 in the range of the correction value (M) from 140 to 250. That is, for example, the compatibility degree (A2) is a value within a range from 0 to 255.

When the compatibility degrees (A11) and (A12) are calculated, the compatibility degree calculator (28) determines, for each distance (L), a compatibility degree (A2) having a smaller value among the compatibility degrees (A11) and (A12) as the compatibility degree at the distance (L) (hereinafter, it is also referred to as “compatibility degree A10”). As described above, for example, the compatibility degrees (A11) and (A12) are values within a range from 0 to 255. Therefore, for example, the compatibility degree (A10) is a value within a range from 0 to 255.

Then, for example, the compatibility degree calculator (28) weights the compatibility degree (A10) and the compatibility degree (A2) for each distance (L), and adds the weighted compatibility degree (A10) and the weighted compatibility degree (A2). Then, the compatibility degree calculator (28) normalizes the addition result. Hereinafter, the addition result normalized by the compatibility degree calculator (28) is also referred to as “weighted compatibility degree Q”. The weighted compatibility degree (Q) is an example of normalized data.

More specifically, for example, the compatibility degree calculator (28) normalizes the addition result of the compatibility degree (A10) multiplied by a predetermined weighting coefficient (K1) and the compatibility degree (A2) multiplied by a predetermined weighting coefficient (K2) using the addition value of the weighting coefficient (K1) and the weighting coefficient (K2) to calculate the weighted compatibility degree (Q).

Specifically, for example, the compatibility degree calculator (28) substitutes the compatibility degree (A10) and the compatibility degree (A2) into the following equation (7). In the equation (7), G is a weighted compatibility degree (Q) and U is a predetermined coefficient.

$$Q = U \times \frac{K 1 \times A 10 + K 2 \times A 2}{K 1 + K 2} \qquad ( 7 )$$

For example, the weighted compatibility degree (Q) is a value in the range from 0 to 1. As described above, the compatibility degree (A10) and (A2) are values in the range from 0 to 255. The predetermined coefficient (U) in the equation (7) is a coefficient for converting the value of the weighted compatibility degree (Q) from a value in the range from 0 to 255 to a value in the range from 0 to 1. Specifically, for example, the predetermined coefficient (U) is an inverse of a value obtained by averaging the maximum value of the compatibility degree (A10) and the maximum value of the compatibility degree (A2).

In the present embodiment, for example, the value of the weighting coefficient (K1) is 2 and the value of the weighting coefficient (K2) is 1. The compatibility degree calculator (28) may be configured to calculate the weighted compatibility degree (Q) by weighting the compatibility degree (A11) corresponding to the Doppler velocity width (σ), the compatibility degree (A12) corresponding to the vector similarity degree (CPA), and the compatibility degree (A2) corresponding to the correction value (M) without determining the compatibility degree (A10), and adding the compatibility degree (A11) after weighting, the compatibility degree (A12) after weighting, and the compatibility degree (A2) after weighting.

As described above, the Doppler velocity width (σ) of the rain clutter (C21) is different from the Doppler velocity width (σ) of the land clutter (C22). The vector similarity degree (CPA) of the rain clutter (C21) is different from the vector similarity degree (CPA) of the land clutter (C22). Therefore, the weighted compatibility degree (Q) of rain clutter (C21) is different from the weighted compatibility degree (Q) of land clutter (C22). For example, the weighted compatibility degree (Q) of rain clutter (C21) is close to 1 and the weighted compatibility degree (Q) of land clutter (C22) is close to 0.

Referring again to FIG. 1, the compatibility degree calculator (28) outputs the calculated weighted compatibility degree (Q) at each distance (L) to the clutter suppressor (29) and the determiner (30).

Clutter suppression—The clutter suppressor (29) performs suppression procedure for suppressing clutter (C2) based on the compatibility degree (A10) and the compatibility degree (A2).

More specifically, for example, the clutter suppressor (29) performs suppression procedure using normalized data obtained by adding the weighted compatibility degree (A10) and the weighted compatibility degree (A2) calculated by the compatibility degree calculator (28), that is, the weighted compatibility degree (Q).

More specifically, for example, the clutter suppressor (29) performs a threshold calculation procedure configured to calculate a threshold (Hereinafter, it is also referred to as “suppression threshold”) for suppressing clutter (C2) based on the weighted compatibility degree (Q) received from the compatibility degree calculator (28). Further, the threshold calculation procedure is performed to calculate the threshold value. In the suppression procedure, the clutter suppressor (29) subtracts the suppression threshold value from the echo data.

For example, in the threshold calculation procedure, the clutter suppressor (29) calculates a suppression threshold value (Tha), which is the suppression threshold value in the azimuth direction, and a suppression threshold value (Thb), which is the suppression threshold value in the distance direction.

For example, the clutter suppressor (29) calculates the suppression threshold value (Tha) and the suppression threshold value (Thb) for each reflected signal (SD) received from the A/D converter (26) by substituting the weighted compatibility degree (Q) received from the compatibility degree calculator (28) into the following equations (8) and (9). In equations (8) and (9), i is an integer equal to or greater than 0 and equal to or less than the number of samples N, W1 is a filter coefficient in the azimuth direction, W2 is a filter coefficient in the distance direction, and S[i] is echo data based on the reflected signal (SD).

$$Tha [ i ] = Tha [ i ] \times W 1 \times ( 1 - Q ) + ( S [ i ] \times ( 1 - W 1 \times ( 1 - Q ) ) ) \qquad ( 8 )$$

$$Thb [ i ] = Thb [ i - 1 ] \times W 2 \times ( 1 - Q ) + ( Tha [ i ] \times ( 1 - W 2 ) ( ( 1 - Q ) ) ) \qquad ( 9 )$$

When the clutter suppressor calculates the suppression threshold values (Tha) and (Thb), it subtracts the suppression threshold value (Thb) from the echo data and outputs the subtracted echo data to the display processor (202).

As described above, the weighted compatibility degree (Q) of the rain clutter (C21) is different from the weighted compatibility degree (Q) of the land clutter (C22). Therefore, the suppression threshold value (Tha) corresponding to the rain clutter (C21) is different from the suppression threshold value (Tha) corresponding to the land clutter (C22), and the suppression threshold value (Thb) corresponding to the rain clutter (C21) is different from the suppression threshold value (Thb) corresponding to the land clutter (C22). Therefore, for example, the clutter suppressor (29) may perform procedures in which one of the rain clutter (C21) and the land clutter (C22) is suppressed and the other is not suppressed according to the values of the suppression threshold values (Tha) and (Thb).

For example, the clutter suppressor (29) suppresses the rain clutter (C21) and may not suppress the land clutter (C22) when the value of the weighted compatibility degree (Q) is close to 1 in Equations (8) and (9). Thus, it is possible to suppress deterioration in visibility of the land clutter (C22).

The display processor (202) displays an echo image in the detection target area on the display device based on the echo data received from the clutter suppressor (29).

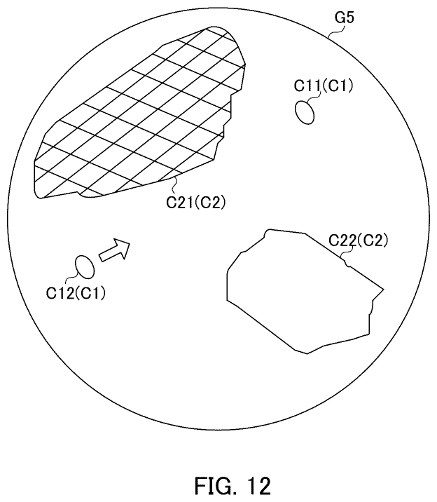

FIG. 12 is a diagram showing another example of the echo image displayed by the radar apparatus (301), according to the embodiment of the present invention. FIG. 12 shows an echo image (G5) in the case where the clutter suppressor (29) suppresses rain clutter (C21) and may not suppress land clutter (C22) in the suppression procedure.

Referring to FIGS. 1 and 12, when the clutter suppressor (29) suppresses rain clutter (C21), the intensity of the rain clutter (C21), that is, the echo level of the rain clutter (C21), becomes smaller than the echo level of the rain clutter (C21) before the suppression procedure. For example, in the echo image (G5), the echo level of the rain clutter (C21) is smaller than the echo level of the echo image (G2) shown in FIG. 4. Therefore, in the example shown in FIG. 12, the rain clutter (C21) is hatched differently from the rain clutter (C21) shown in FIG. 4. Moreover, the stationary object target echo (C11), the moving object target echo (C12), and the land clutter (C22) that is not suppressed are not hatched.

For example, the determiner (30) makes a determination regarding the clutter (C2) (Hereinafter, it is also referred to as “clutter determination procedure”) based on the performance of the compatibility degree (A10) and the compatibility degree (A2). In the present embodiment, the determiner (30) makes the determination regarding rain clutter (C21) based on the compatibility degree (A10) and the compatibility degree (A2) in the clutter determination procedure.

More specifically, for example, the determiner (30) determines whether or not the weighted compatibility degree (Q) received from the compatibility degree calculator (28) is equal to or greater than a predetermined threshold value (Tc) for each reflected signal (SD) received from the A/D converter (26) in the clutter determination procedure.

When the weighted compatibility degree (Q) from the compatibility degree calculator (28) is equal to or greater than the predetermined threshold value (Tc), the determiner (30) determines that the reflected signal (SD) corresponding to the weighted compatibility degree (Q) is a reflected signal based on the rain clutter (C21). By the way, when determining whether or not the reflected signal received at time (t) is the rain clutter (C21) based on the difference value between the intensity of the reflected signal received at a certain time (t) and the intensity of the reflected signal received at a time before time (t), if the difference value is small, the reflected signal may be misjudged as noise. On the other hand, in the present embodiment, the clutter determination procedure is performed using the weighted compatibility degree (Q) calculated by fuzzy inference, so that it is possible to suppress the misjudgment of the received reflected signal as noise.

Then, the determiner (30) outputs the determination result information (P4) indicating the determination result to the display processor (202). For example, the determiner (30) outputs the information indicating the distance (L) corresponding to the reflected signal (SD) whose weighted compatibility degree (Q) is not less than the predetermined threshold value (Tc) as the determination result information (P4) to the display processor (202).

On the other hand, when the weighted compatibility degree (Q) from the compatibility degree calculator (28) is less than the predetermined threshold value (Tc), then the determiner (30) determines that the reflected signal (SD) corresponding to the weighted compatibility degree (Q) is not the reflected signal based on rain clutter (C21).

For example, the display processor (202) performs a process of displaying the determination result by the determiner (30). More specifically, for example, when the determination result information (P4) is received from the determiner (30), the display processor (202) displays the portion corresponding to the distance (L) indicated by the determination result information (P4) in a color different from that of the other portions in the echo image. That is, the display processor (202) displays the rain clutter (C21) in the color different from that of the target echo (C1) or the like in the echo image.

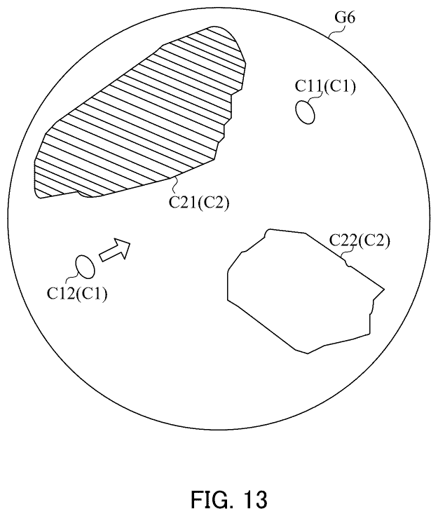

FIG. 13 is a diagram showing another example of the echo image displayed by the radar apparatus (301), according to the embodiment of the present invention.

Referring to FIG. 13, in the echo image (G6), the land clutter (C22) and the rain clutter (C21) is displayed in the color different from that of the target echo (C1) are hatched.

In the radar apparatus (301), the radar device (201) may be configured not to include the determiner (30). That is, the radar apparatus (301) may be configured not to perform clutter determination procedure.

The radar apparatus (301) according to the embodiment of the present invention includes a computer including a memory, and a processor such as a CPU in the computer reads a program including part or all of the steps of the following flowchart from the memory and executes the program. The program of the radar apparatus (301) may be installed from the outside. The program of the radar apparatus (301) is distributed in a state stored in a recording medium or via a communication line.

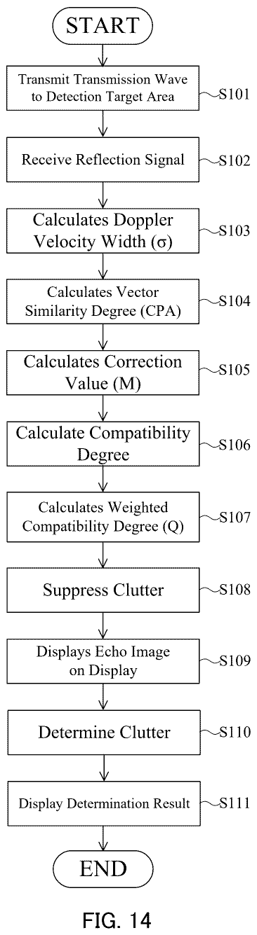

FIG. 14 is a flowchart defining an operation procedure when the radar apparatus (301) performs suppression procedure, according to the embodiment of the present invention.

Referring to FIG. 14, first, the radar apparatus (301) transmits the transmission wave to a detection target area (step 101).

Further, the radar apparatus (301) receives the reflected signal based on the transmission wave (step 102).

Further, the radar apparatus (301) calculates the Doppler velocity width (σ) of the received reflected signal (i.e., a reflected signal) (step 103).

Further, the radar apparatus (301) calculates the vector similarity degree (CPA) of the received reflected signal (step 104).

Further, the radar apparatus (301) calculates the correction value (M) of the amplitude of the received reflected signal (step 105). Steps 103 to 105 may be performed in a different order or in parallel.

Further, the radar apparatus (301) performs the compatibility degree calculation process for each of the calculated Doppler velocity width (σ), vector similarity degree (CPA), and correction value (M). For example, as described above, the radar apparatus (301) calculates the compatibility degree (A11), the compatibility degree (A12), and the compatibility degree (A2) corresponding to the Doppler velocity width (σ), vector similarity degree (CPA), and correction value (M), respectively, by using the membership function (F) for each of the Doppler velocity width (σ), vector similarity degree (CPA), and correction value (M) (step 106).

Further, the radar apparatus (301) calculates the weighted compatibility degree (Q) using the compatibility degree (A11), the compatibility degree (A12), and the compatibility degree (A2) (step 107).

Further, the radar apparatus (301) performs the suppression process for suppressing clutter (C2) using data obtained by normalizing the calculated weighted compatibility degree (Q), that is, the weighted compatibility degree (Q). For example, as described above, the radar apparatus (301) calculates a suppression threshold value for suppressing clutter (C2) using the weighted compatibility degree (Q), and subtracts the suppression threshold value from the echo data (step 108).

Further, the radar apparatus (301) displays the echo image in the detection target area on the display device based on the echo data after the suppression process (step 109).

Further, the radar apparatus (301) performs a clutter determination process based on the calculated weighted compatibility degree (Q) (step 110).

Further, the radar apparatus (301) displays the determination result of the clutter determination procedure on the display device (step 111). It should be noted that the procedure of steps (S108) and (S109) may be executed in the same order as the procedure of steps (S110) and (S111), or may be executed in parallel.

In the suppression procedure, the radar apparatus (301) may substitute echo data whose compatibility degree is equal to or greater than the predetermined threshold value with 0.

Referring again to FIG. 1, in the modification, for example, the compatibility degree calculator (28) outputs the compatibility degree (A10) and the compatibility degree (A2) to the clutter suppressor (29).

The clutter suppressor (29) confirms whether the compatibility degree (A10) received from the compatibility degree calculator (28) is equal to or greater than a threshold value (Th21). The clutter suppressor (29) also confirms whether the compatibility degree (A2) received from the compatibility degree calculator (28) is equal to or greater than a threshold value (Th22). The threshold value (Th21) is an example of a first threshold value and the threshold value (Th22) is an example of a second threshold value.

For example, in the suppression procedure, the clutter suppressor (29) substitutes echo data in which the compatibility degree (A10) is equal to or greater than the threshold value (Th21) or in which the compatibility degree (A2) is equal to or greater than the threshold value (Th22) with 0.

On the other hand, the clutter suppressor (29) may not substitute echo data in which the compatibility degree (A10) is less than the threshold value (Th21) and the compatibility degree (A2) is less than the threshold value (Th22) with 0. The radar apparatus (301) may determine echo data in which the compatibility degree (A10) is equal to or greater than the threshold value (Th21) or in which the compatibility degree (A2) is equal to or greater than the threshold value (Th22) as echo data containing noise and substitute the echo data with 0 by the same procedure as the suppression procedure in the modified example.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processor. A processor can be a microprocessor, but in the alternative, the processor can be a controller, microcontroller, or state machine, combinations of the same, or the like. A processor can include electrical circuitry configured to process computer-executable instructions. In another embodiment, a processor includes an application specific integrated circuit (ASIC), a field programmable gate array (FPGA) or other programmable device that performs logic operations without processing computer-executable instructions. A processor can also be implemented as a combination of computing devices, e.g., a combination of a digital signal processor (DSP) and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can”, “could”, “might” or “may” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C. The same holds true for the use of definite articles used to introduce embodiment recitations. In addition, even if a specific number of an introduced embodiment recitation is explicitly recited, those skilled in the art will recognize that such recitation should typically be interpreted to mean at least the recited number (e.g., the bare recitation of “two recitations” without other modifiers, typically means at least two recitations, or two or more recitations).

It will be understood by those within the art that, in general, terms used herein, are generally intended as “open” terms (e.g., the term “including” should be interpreted as “including but not limited to” the term “having” should be interpreted as “having at least” the term “includes” should be interpreted as “includes but is not limited to” etc.).

For expository purposes, the term “horizontal” as used herein is defined as a plane parallel to the plane or surface of the floor of the area in which the system being described is used or the method being described is performed, regardless of its orientation. The term “floor” can be interchanged with the term “ground” or “water surface.” The term “vertical” refers to a direction perpendicular to the horizontal as just defined. Terms such as “above”, “below”, “bottom”, “top”, “side”, “higher”, “lower”, “upper”, “over” and “under” are defined with respect to the horizontal plane.

As used herein, the terms “attached”, “connected”, “mated” and other such relational terms should be construed, unless otherwise noted, to include removable, moveable, fixed, adjustable, and/or releasable connections or attachments. The connections/attachments can include direct connections and/or connections having intermediate structure between the two components discussed.

Numbers preceded by a term such as “approximately”, “about” and “substantially” as used herein include the recited numbers, and also represent an amount close to the stated amount that still performs a desired function or achieves a desired result. For example, the terms “approximately”, “about” and “substantially” may refer to an amount that is within less than 10% of the stated amount. Features of embodiments disclosed herein preceded by a term such as “approximately”, “about” and “substantially” as used herein represent the feature with some variability that still performs a desired function or achieves a desired result for that feature.

The above embodiments should be considered exemplary and not restrictive in all respects. The scope of the present invention is shown by the claims, not the description, and is intended to include all changes in a sense equivalent to and within the claims.

It should be emphasized that many variations and modifications may be made to the above-described embodiments, the elements of which are to be understood as being among other acceptable examples. All such modifications and variations are intended to be included herein within the scope of this disclosure and protected by the following claims.

What is claimed is:

1. A radar comprising:
a transmitter configured to transmit electromagnetic waves; and
processing circuitry configured:
to acquire amplitude information indicating an amplitude of a reflected signal reflected by a target and phase information indicating a phase of the reflected signal;
to calculate a compatibility degree of clutter included in echo data based on the reflected signal using a membership function for each of the amplitude information and the phase information, and
to calculate a first compatibility degree corresponding to the amplitude information and a second compatibility degree corresponding to the phase information; and
to suppress the clutter based on the first compatibility degree and the second compatibility degree.

2. The radar according to claim 1, wherein:
the processing circuitry is further configured:
to determine the clutter based on the first compatibility degree and second compatibility degree; and
to display a determination result.

3. The radar according to claim 1, wherein:
the phase information includes a Doppler velocity width of the reflected signal.

4. The radar according to claim 1, wherein:
the phase information includes a vector similarity degree of the reflected signal represented by the following equation (1):
$$CPA = \vert {\sum }_{i = 1}^{N} xi \vert / [ {\sum }_{i = 1}^{N} \vert xi \vert ] \qquad ( 1 )$$
wherein CPA is the vector similarity degree, N is the number of samples, and xi is a complex component of the reflected signal.

5. The radar according to claim 3, wherein:
the processing circuitry is further configured:
to perform a filtering procedure to smooth a waveform indicated by the reflected signal, and
the amplitude information includes a correction value of the amplitude of the reflected signal after the filtering procedure.

6. The radar according to claim 4, wherein:
the processing circuitry is further configured:
to perform a filtering procedure to smooth a waveform indicated by the reflected signal, and
the amplitude information includes a correction value of the amplitude of the reflected signal after the filtering procedure.

7. The radar according to claim 1, wherein:
the processing circuitry is further configured:
to suppress the clutter using normalized data obtained by normalizing the addition result.

8. The radar according to claim 2, wherein:
the processing circuitry is further configured:
to suppress the clutter using normalized data obtained by normalizing the addition result.

9. The radar apparatus according to claim 7, wherein:
the processing circuitry is further configured:
to perform a threshold calculation procedure to calculate a threshold for suppressing the clutter based on the normalized data, and
to subtract the threshold from the echo data in the suppression procedure.

10. The radar apparatus according to claim 8, wherein:
the processing circuitry is further configured:
to perform a threshold calculation procedure to calculate a threshold for suppressing the clutter based on the normalized data, and
to subtract the threshold from the echo data in the suppression procedure.

11. The radar according to claim 9, wherein:
the transmitter is further configured to transmit the electromagnetic wave via a transmission antenna; and
the processing circuitry is further configured
to calculate a first threshold in the rotational direction of the transmission antenna (23) using the following equation (2);
$$Tha [ i ] = Tha [ i ] \times W 1 \times ( 1 - Q ) + ( S [ i ] \times ( 1 - W 1 \times ( 1 - Q ) ) ) , \qquad ( 2 )$$
to calculate a second threshold in the direction from the radar apparatus (301) toward the target using the following equation (3);
$$Thb [ i ] = Thb [ i - 1 ] \times W 2 \times ( 1 - Q ) + ( Tha [ i ] \times ( 1 - W 2 \times ( 1 - Q ) ) ) ; \qquad ( 3 )$$
and
to subtract, in the suppression procedure, the second threshold from the echo data, wherein:
Tha[i] is the first threshold; Thb[i] is the second threshold; S[i] is the echo data; W1 and W2 are coefficients; Q is the normalized data; and i is an integer equal to or greater than 0 and equal to or less than the number of samples.

12. The radar according to claim 10, wherein:
the transmitter is further configured to transmit the electromagnetic wave via a transmission antenna; and
the processing circuitry is further configured
to calculate a first threshold in the rotational direction of the transmission antenna (23) using the following equation (2);
$$T h a [ i ] = Tha [ i ] \times W 1 \times ( 1 - Q ) + ( S [ i ] \times ( 1 - W 1 \times ( 1 - Q ) ) ) , \qquad ( 2 )$$
to calculate a second threshold in the direction from the radar apparatus (301) toward the target using the following equation (3);
$$Thb [ i ] = Thb [ i - 1 ] \times W 2 \times ( 1 - Q ) + ( T h a [ i ] \times ( 1 - W 2 \times ( 1 - Q ) ) ) ; \qquad ( 3 )$$
and
to subtract, in the suppression procedure, the second threshold from the echo data, wherein:
Tha[i] is the first threshold; Thb[i] is the second threshold; S[i] is the echo data; W1 and W2 are coefficients; Q is the normalized data; and i is an integer equal to or greater than 0 and equal to or less than the number of samples.

13. The radar according to claim 1, wherein:
the processing circuitry is further configured to substitute the echo data with zero (0) when the first compatibility degree is equal to or greater than a predetermined first threshold or the second compatibility degree is equal to or greater than a predetermined second threshold.

14. The radar according to claim 2, wherein:
the processing circuitry is further configured to substitute the echo data with zero (0) when the first compatibility degree is equal to or greater than a predetermined first threshold or the second compatibility degree is equal to or greater than a predetermined second threshold.

15. A clutter suppression method for a radar apparatus, comprising:
transmitting an electromagnetic wave;
acquiring amplitude information indicating an amplitude of a reflected signal reflected by a target and phase information indicating a phase of the reflected signal;
calculating a compatibility degree of clutter included in echo data based on the reflected signal using a membership function (F) for each of the amplitude information and the phase information;
calculating a first compatibility degree corresponding to the amplitude information and a second compatibility degree corresponding to the phase information; and
suppressing the clutter based on the first compatibility degree and the second compatibility degree.

16. A clutter suppression program for a radar apparatus,
the clutter suppression program causes a computer to execute a process of:
transmitting an electromagnetic wave;
acquiring amplitude information indicating an amplitude of a reflected signal reflected by a target and phase information indicating a phase of the reflected signal;
calculating a compatibility degree of clutter included in echo data based on the reflected signal by using a membership function for each of the amplitude information and the phase information;
calculating a first compatibility degree corresponding to the amplitude information and a second compatibility degree corresponding to the phase information; and
suppressing the clutter based on the first compatibility degree and the second compatibility degree.
